(19) United States
(12) Patent Application Publication
(10) Pub. No.: US 2019/0334266 A1
(43) Pub. Date: Oct. 31, 2019

(54) DOUBLE STACK CONNECTOR

(71) Applicant: HEWLETT PACKARD ENTERPRISE DEVELOPMENT LP, Houston, TX (US)

(72) Inventors: Victoria Doehring-Patel, Houston, TX (US); Kevin Conn, Montgomery, TX (US)

(21) Appl. No.: 15/966,392

(22) Filed: Apr. 30, 2018

(51) Int. Cl. H01R 12/73; H01R 25/00; H01R 12/70; H01R 43/20; H01R 43/16; H01R 13/04

(52) U.S. Cl. CPC H01R 12/73; H01R 25/006; H01R 13/04; H01R 43/205; H01R 43/16; H01R 12/7076

(57) ABSTRACT

A double stack connector electrically connects a PCB to a first and a second M.2 module. The connector includes a plurality of pins that form a first row of pins and a second row of pins for connection to PCB at one end, and to the first and second M.2 modules at a second end. The PCB is able to concurrently operate the first and second M.2 modules via the first and the second row of pins of the connector.

### BACKGROUND

The server platform industry continues to demand higher levels of data storage capacity and performance within smaller space constraints. To facilitate this need, an M.2 standard specification, formerly known as the Next Generation Form Factor (“NGFF”), was designed to provide design criteria that could maximize usage of printed circuit board (“PCB”) space while minimizing the form factor of the devices and connectors connected to the PCB. In particular, the M.2 specification provides design criteria such as pin locations and pin spacing for various components.

For example, the M.2 specification provides design criteria that allows PCBs to receive and mate with connectors. Further the M.2 specification provides design criteria for connectors to connect and mate to the PCB, as well as design criteria for sockets of the connectors to receive and mate with storage devices such as solid state devices (“SSDs”). More specifically, the M.2 specification provides standardized pin outs of the PCBs, connectors, and SSDs to support full functionality. Even with the M.2 specification permitting the server platform industry to achieve higher levels of data storage capacity and performance within smaller space constraints, each server platform has generally been limited with the number of SSDs that can be utilized at one time.

### BRIEF DESCRIPTION OF THE DRAWINGS

The present disclosure is best understood from the following detailed description when read with the accompanying Figures. It is emphasized that, in accordance with the standard practice in the industry, various features are not drawn to scale. In fact, the dimensions of the various features may be arbitrarily increased or reduced for clarity of discussion.

FIG. 1 is an isometric drawing of a double stack connector assembly in accordance with at least some embodiments of the subject matter claimed below.

FIG. 2 is an isometric drawing of a double stack connector, according to one embodiment of the technique disclosed herein.

FIG. 3 provides a side view of the double stack connector assembly in FIG. 1.

FIG. 4 provides a pin out spreadsheet of the double stack connector shown in FIG. 2 that includes two rows of pins.

FIGS. 5A-5D provides a pin out diagram according to one embodiment of the double stack connector.

FIG. 6 provides a cutaway isometric drawing of the double stack connector shown in FIG. 3 to illustrate a bent pin in accordance with some embodiments.

FIG. 7 provides a block diagram of the method of building a connector according to one particular embodiment.

### DETAILED DESCRIPTION

Illustrative embodiments of the subject matter claimed below will now be disclosed. In the interest of clarity, not all features of an actual implementation are described in this specification. It will be appreciated that in the development of any such actual embodiment, numerous implementation-specific decisions will be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

A connector is disclosed herein that maintains the same M.2 standard footprint on a printed circuit board (“PCB”) while doubling the number of M.2 modules (e.g., solid state devices such as SIM cards). Embodiments use a reduced number of pins relative to what one would get by simply stacking conventional M.2 modules. Some M.2 standard signals are omitted and their pins repurposed. Also, some other signals (e.g., power signals) share pins instead of each using a separate pin. In some embodiments, additional pins are added over and above those called for by the M.2 standard.

In one embodiment, a connector may comprise a housing body. The housing body may include a front face, a back face, an upper portion, and a bottom portion. The housing body may further define a plurality of sockets that extend from the front face of the housing body towards the back face of the housing body. The plurality of sockets may be vertically positioned between a bottom portion of the housing body and a top portion of the housing body, wherein each of the sockets may be configured to receive a M.2 module with an M.2 standard form factor. The connector may further include a plurality of pins that extend through the housing body to the plurality of sockets. The plurality of pins may extend out of the bottom portion of the housing body, and may be arranged in a first row of pins and a second row of pins. In one embodiment, the first row of pins and the second row of pins may be configured according to an M.2 standard specification for connection to a printed circuit board (“PCB”). In one embodiment, the plurality of pins, which are at least partially positioned within the housing body, may electrically connect each of the M.2 modules to the printed circuit board to permit concurrent operation of the M.2 modules.

In one embodiment, a connector that electrically connects a first and a second solid state device (“SSD”) to a printed circuit board (“PCB”) is disclosed. The connector may include a housing body that defines a first socket and a second socket that are configured to receive the first SSD and the second SSD respectively. The connector may also include a first row of pins and a second row of pins that include PCB contacts and socket contacts. The first and second rows of pins may include a first group of pins and a second group of pins. In one embodiment, the PCB contacts of the first and second rows of pins extend outward from a bottom portion of the housing body and may be positioned in an M.2 configuration. The PCB contacts of the first and second rows of pins may be for electrical connection to the PCB. In one embodiment, the first group of pins may extend through the housing body to the first socket for electrical connection to the first SSD, and the second group of pins may extend through the housing body to the second socket for electrical connection to the second SSD, wherein the first and second row of pins permit concurrent operation of the first and second SSDs.

The technique disclosed herein also includes a method of building a connector that may electrically connect a first and a second solid state device (“SSD”) to a printed circuit board (“PCB”), wherein the connector may allow the first and the second SSDs to be concurrently operated by the PCB. The method may include forming a housing body that includes a first face, a back face, an upper portion, and a bottom portion. The housing body may further define a first socket and a second socket, wherein the first and the second sockets extend from the first face of the housing body towards the back face of the housing body. The first and second sockets may be vertically positioned within the housing body and configured to receive the first and the second SSDs. In one step, the method of building a connector may include positioning a portion of a plurality of pins within the housing body. The plurality of pins may include PCB contacts and socket contacts, and the plurality of pins may also include a first group of pins and a second group of pins.

The method may also include positioning the PCB contacts of the plurality of pins in a first row and a second row, each with an M.2 configuration. The PCB contacts of the plurality of pins may extend outside the bottom portion of the housing body to electrically connect to the PCB. In one embodiment, the method may include routing the first group of pins from the bottom portion of the housing body to the first socket, the socket contacts of the first group of pins may be used for electrical connection to the first SSD. The method may further include routing the second group of pins from the bottom portion of the housing body to the second socket. The socket contacts of the second group of pins may be used for electrical connection to the second SSD.

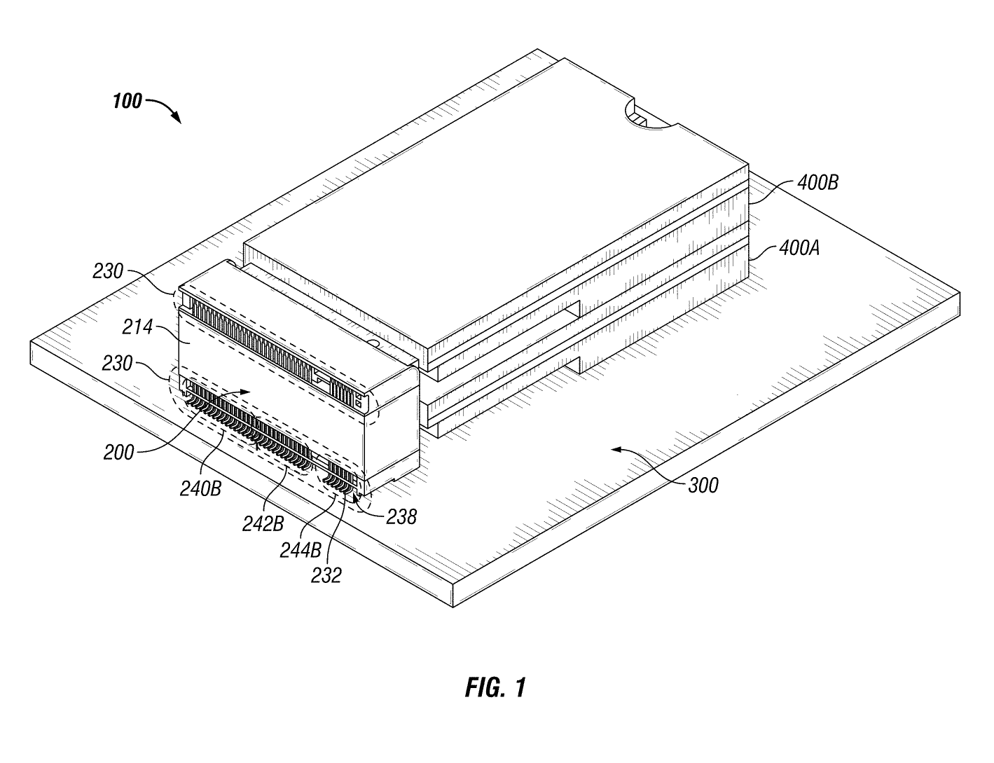

Referring now to FIG. 1, an isometric drawing of a double stack connector assembly 100 is shown, according to one embodiment of the subject matter claimed below. The double stack connector assembly 100 includes a double stack connector 200 that may be electrically connected to a printed circuit board (“PCB”) 300. The double stack connector 200 may be further electrically connected to a plurality of M.2 modules, such as solid state devices (SSDs) 400 according to the M.2 standard. In one embodiment, the connector 200 may be connected to a first SSD 400A and a second SSD 400B. Note that alternative embodiments may include alternative kinds of M.2 modules.

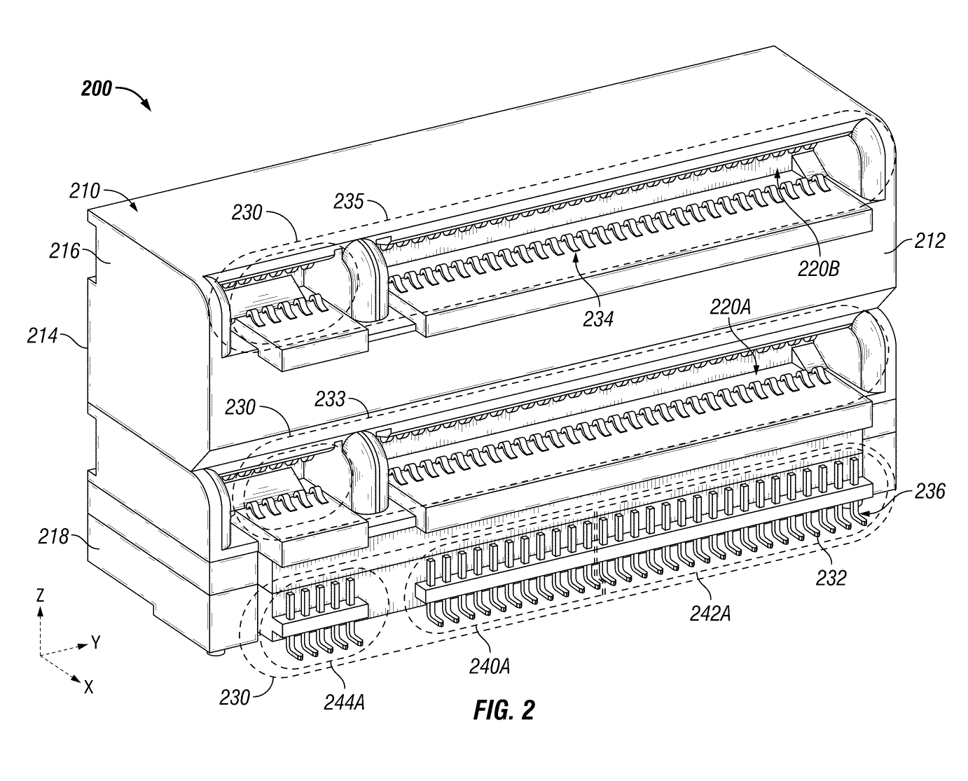

FIG. 2 provides an isometric drawing of the double stack connector 200 in FIG. 1 according to one particular embodiment. The connector 200 may include a housing body 210 that may comprise a front face 212 and a back face 214. The front face 212 may include a horizontal facing side of the body 210 on which the M.2 modules are inserted, such as the side of the body 210 that is facing in the +x direction in FIGS. 1-3. The back face 214 may be a horizontal facing side of the body 210 positioned opposite the front face 212 of the body 21, such as the side of the body 210 that is facing in the −x direction in FIGS. 1-3.

The body 210 may also comprise an upper portion 216 and a bottom portion 218. In one embodiment, the upper portion 216 is the top fifty percent of the body 210 in the z direction in FIGS. 1-3, and the bottom portion 218 is the lower fifty percent of the body 210 in the z direction in FIGS. 1-3. The housing body 210 may define a plurality of sockets such as a first socket 220A, and a second socket 220B. The first socket 220A and the second socket 220B may include recesses that extend inward from the front face 212 toward the back face 214 of the housing body 210. In one embodiment, the first socket 220A is positioned in the bottom portion 218 of the body 210 and the second socket 220B is positioned in the upper portion 218 of the body 210. In one embodiment shown in FIG. 2, the first and second sockets 220A, 220B are in vertical alignment. The first and second sockets 220A, 220B may be in vertical alignment when the first and second sockets 220A, 220B are parallel to one another and both ends of the first and second sockets 220A, 220B are in approximately the same x-y position as shown in the Figures. As used herein, ‘vertical’ refers to a direction that is approximately parallel to the z-axis illustrated in the Figures. The z-axis is fixed relative to the connector 200, and is such that, when the connector 200 is connected to a PCB 300, the x-axis and y-axis are roughly perpendicular to a surface of the PCB 300. However, it is contemplated that the first and second sockets 220A, 220B may not be parallel or include the same x-y positioning. The first and second sockets 220A, 220B may be configured to receive and electrically connect to the first SSD 400A and the second SSD 400B shown in FIG. 1.

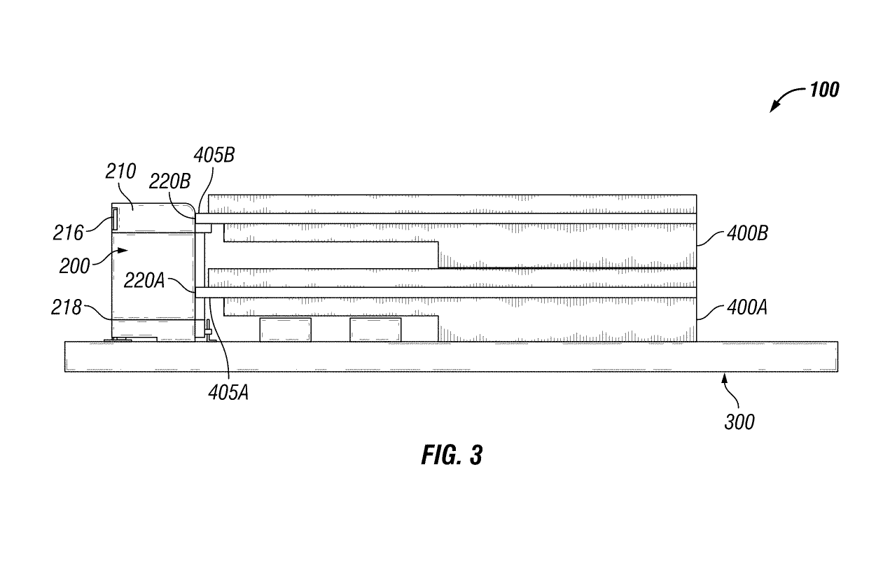

In FIG. 3, which provides a side view drawing of the isometric drawing of the double stack connector assembly 100 shown in FIG. 1, the first SSD 400A may include a first edge connector 405A that is configured according to the M.2 standard, and may be received by and electrically connected to the first socket 220A of the connector 200. The second SSD 400B may also include a second edge connector 405B that is configured according to the M.2 standard and may be received by and electrically connected to the second socket 220B of the connector 200. In one embodiment, the first socket 220A and the second socket 220B may be vertically positioned within the connector housing 210 based on the dimensions of the first and second SSDs 400A, 400B such that the first and second sockets 220A, 220B are aligned with the first and second edge connectors 405A, 405B in a state in which the first and second SSDs 400A, 400B are stacked on top of one another and in alignment with one another. More specifically, in one embodiment, the locations of the first and second sockets 220A, 220B are such that, in a state in which the connector 200 is connected to the PCB 300, the first and second SSDs 400A, 400B are connected to the connector 200 while the first SSD 400A is in contact with the PCB 300 and the second SSDs 400A is stacked on and in contact with the second SSD 400B.

Returning to FIG. 2, the connector 200 may include a plurality of pins 230 extending from an exterior of the housing body 210 near a bottom side thereof through the housing body 210 into the first socket 220A and the second socket 220B. Each pin of the plurality of pins 230 may include a PCB contact 232 (only one indicated) that terminates on the exterior of the housing body 210 near a bottom side thereof and that is for electrically connecting to the PCB 300, and a socket contact (or contacts) 234 (only one indicated) that terminate(s) in the first socket 220A and/or the second socket 220B and that is(are) for electrically connecting to one of the SSDs 400A, 400B. In some examples, one or more of the plurality of pins 230 may include a PCB contact 232 and then branch out to include one or more socket contacts 234.

Some of the socket contacts 234 of the plurality of pins 230 (group 233 in FIG. 2) may be positioned within the first socket 220A, and these may be collectively arranged to receive and electrically connect to the first edge connector 405A via the M.2 standard. Similarly, some of socket contacts 234 of the plurality of pins 230 (group 235 in FIG. 2) may be positioned within the second socket 220B, and these may be collectively arranged to receive and electrically connect to the second edge connector 405B via the M.2 standard.

The PCB contacts 232 of the plurality of pins 230 may extend outward from the bottom portion 218 of the connector 200. In one embodiment, the PCB contacts 232 of the plurality of pins 230 may be positioned in a first row 236 along the front face 212 of the connector 200 and a second row 238 may be positioned along the back face 214 of the connector 200 (shown in FIG. 1). However, in another embodiment, the first row 236 and the second row 238 of pins may extend outward from the bottom portion 218 of the connector and be positioned in an alternate manner to the one shown in FIGS. 1 and 2. The PCB contacts 232 may be configured to electrically connect to the PCB 300 by soldering the PCB contacts 232 to leads on the PCB, by plugging the PCB contacts 232 into sockets on the PCB 300, or by any other method known in the art. In one embodiment, the PCB 300 may concurrently operate the first and second SSDs 400A, 400B by using the first and second rows of pins 236, 238 of the connector 200.

In one embodiment, the first row of pins 236 of the plurality of pins 230 may include a first group of pins 240A and a second group of pins 242A, both shown in FIG. 2. The first group of pins 240A may each have a socket contact 234 in the first socket 220A to electrically connect with the first edge connector 405A of the first SSD 400A. The second group of pins 242A may each have a socket contact 234 in the second socket 220B to electrically connect with the second edge connector 405B of the second SSD 400B. The first row of pins 236 may further include a third group of pins 244A that each have two or more socket contacts 234, with one or more in each of the first and the second sockets 220A, 220B to electrically connect to both the first and second edge connectors 405A, 405B of the first and second SSDs 400A, 400B. Although FIG. 2 illustrates specific pins 230 of the first row 236 as being members of the first, second, and third groups 240A, 242A, and 244A, this is merely for convenience of description, and in practice the pins 230 of the first row 236 may be distributed amongst the groups 240A, 242A, and 244A in any manner.

In one embodiment, the second row of pins 238 of the plurality of pins 230 may include a first group of pins 240B and a second group of pins 242B, both shown in FIG. 1. The first group of pins 240B may each have a socket contact 234 in the first socket 220A to electrically connect with the first edge connector 405A of the first SSD 400A. The second group of pins 242B may each have a socket contact 234 in the second socket 220B to electrically connect with the second edge connector 405B of the second SSD 400B. The second row of pins 236 may further include a third group of pins 244B that each have two or more socket contacts 234, with one or more in each of the first and the second sockets 220A, 220B to electrically connect to both the first and second edge connectors 405A, 405B of the first and second SSDs 400A, 400B. Although FIG. 1 illustrates specific pins 230 of the second row 238 as being members of the first, second, and third groups 240B, 242B, and 244B, this is merely for convenience of description, and in practice the pins 230 of the second row 238 may be distributed amongst the groups 240B, 242B, and 244B in any manner.

In order for the double stack connector 200 to be able to have just two rows (i.e., the first row of pins 236 and the second row of pins 238), one or more mechanisms may be employed in the double stack connector 200. In one embodiment, the double stack connector 200 may omit one or more M.2 standard signals that are not used for the first SSD 400A and the second SSD 400B to operate. As used herein, a connector omits an M.2 standard signal when it does not include a pin 230 to carry that signal (i.e., none of its pins 230 are routed to a pin-position that would be reserved for that signal in an M.2 standard pin layout). For example, a portion of the pins that would usually be used for wireless signals, WIFI signals, Bluetooth signals, navigation signals, or other near field signals may be omitted from the connector 200 in the connector 200. In one embodiment, when the double stack connector 200 omits one or more signals, a pin that would otherwise be dedicated to those signals is no longer used. Accordingly, the pins in those designated M.2 positions previously used for the omitted signals may be repurposed for other uses to operate the first SSD 400A and the second SSD 400B via the first and second rows of pins 236, 238. In one embodiment, when a signal is omitted, the connector may still include a pin 230 that has one end that is located in a pin-position that would normally be reserved for the omitted signal according to M.2, but the pin 230 may have its other end(s) routed to a pin-position that would normally be reserved for a different signal.

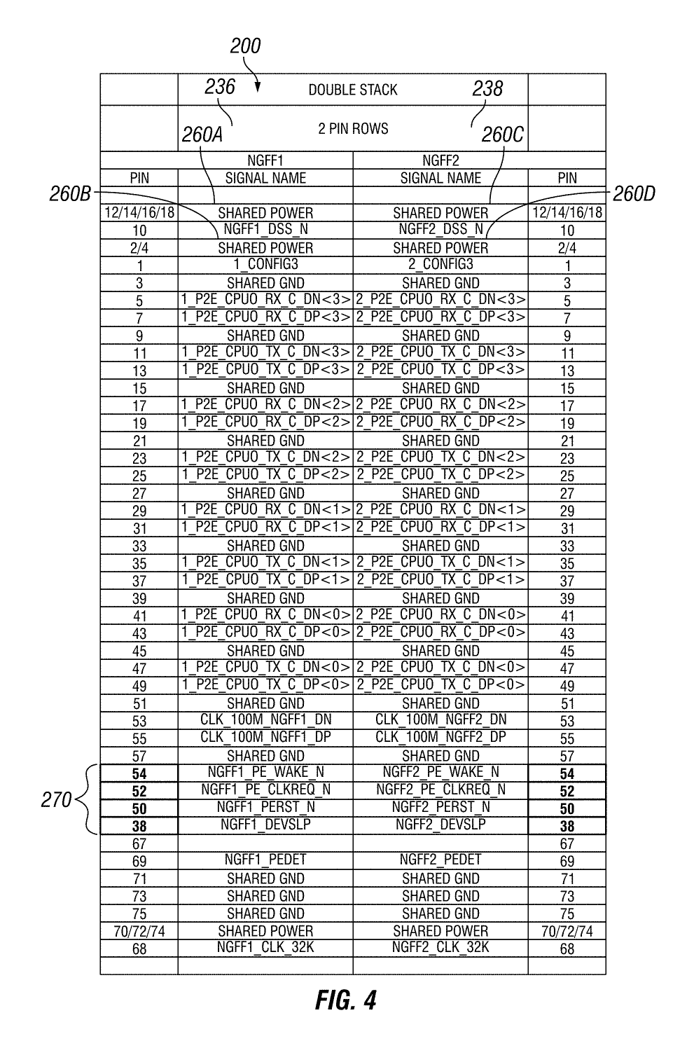

In one embodiment, to reduce the number of pins used by the connector 200 to operate the first SSD 400A and the second SSD 400B, certain pins may transmit signals from the PCB 300 from their PCB contact 232 to two or more socket contacts 234. For example, the connector 200 may include shared power pins 260, as shown in FIG. 4. The pins 260A and 260C, on the first row of pins 236 and the second row of pins 238, respectively, may each be a shared power pin that transmits power from the PCB 300 via a PCB contact 232 to four separate socket contacts 234 labeled 12, 14, 16, and 18 within each socket 220A and 220B. Similarly, pins 260B and 260D, on the first row of pins 236 and the second row of pins 238, respectively, may also each be a shared power pin that transmits power from the PCB 300 via a PCB contact 232 to two separate socket contacts 234 labeled 2 and 4 within each socket 220A and 220B.

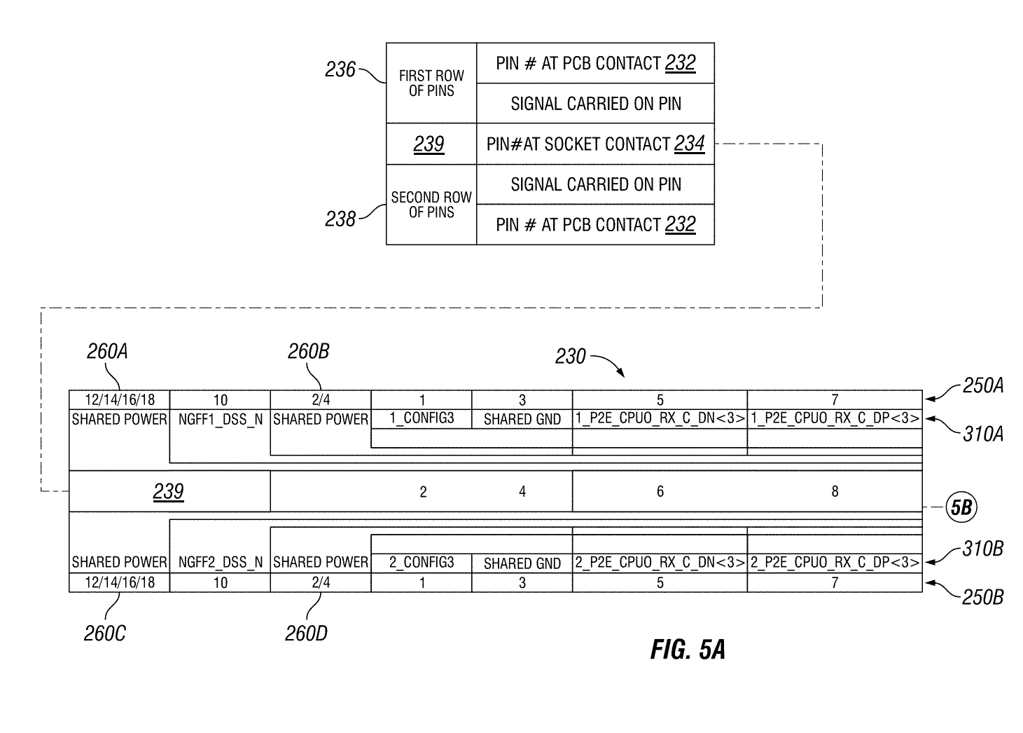

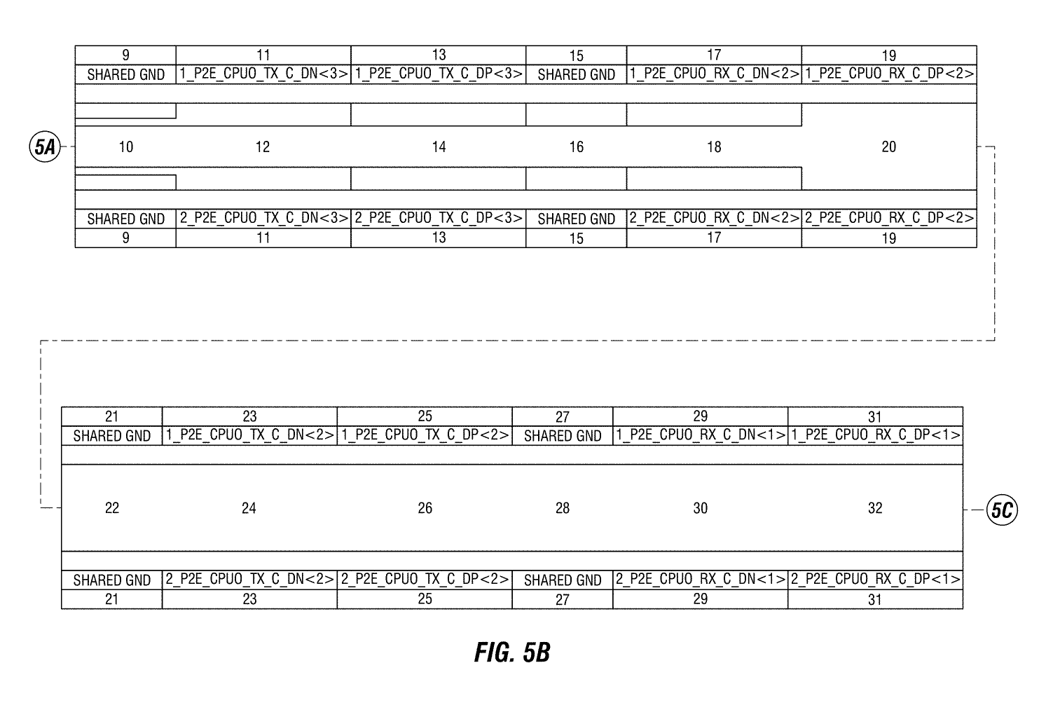

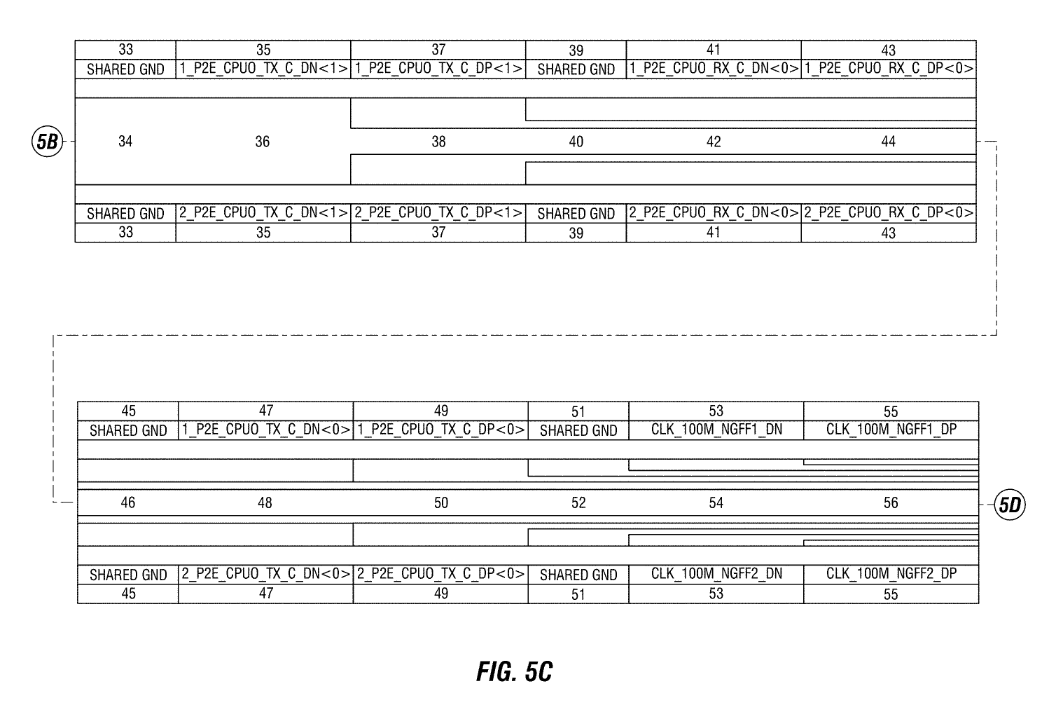

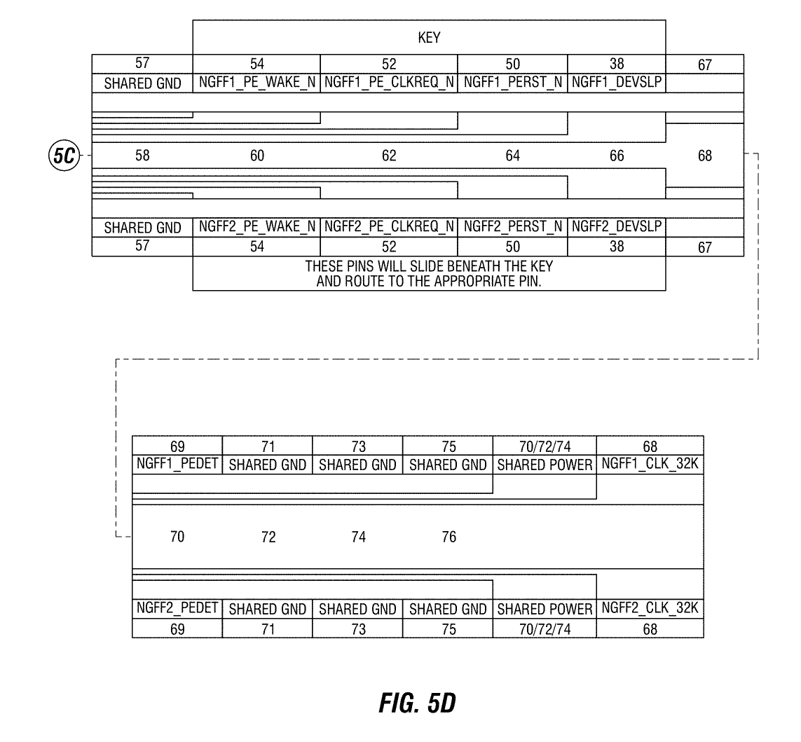

FIGS. 5A-5D provide an alternate pin out diagram according to one embodiment of the double stack connector 200. FIGS. 5A-5D are intended to be read in conjunction with one another, and in conjunction with FIG. 4. In the pin out diagram, a top and bottom row of cells 250A, 250B represent each of the PCB contacts 232 of the plurality of pins 230 that electrically connect to the PCB 300 by means of the first and the second rows of pins 236, 238. Specifically, the top row of cells 250A represent the PCB contacts 232A of the first row of pins 236 that connect to the PCB 300 and the bottom row of cells 250B represent of the PCB contacts 232B of the second row of pins 238 that connect to the PCB 300. The middle portion of the diagram 239 (third row) represents the socket contacts 234 of the plurality of pins 230 that will electrically connect to the first and second SSDs 400A, 400B. The second and fourth row of cells 310A, 310B represent the electrical signals being acquired from the PCB 300, according to one embodiment. With some exceptions, the pins with odd labeled PCB contacts 232 may terminate at socket contacts 234 labeled in the next sequential even number. For example, the PCB contact 232 labeled “1” may terminate in the socket contact 234 labeled “2”, and so forth. In one embodiment, the first row of pins 236 is routed to the first socket 220A, and the second row of pins 238 is routed to the second socket 220B. However, in some embodiments, certain pins within the first or second row of pins 238 could be routed to the other or both sockets 220A, 220B, or certain pins may be routed to multiple socket contacts 234.

As shown in FIG. 5A, the connector 200 may share power signals provided by the PCB 300. In one embodiment, the PCB contact 232 of a first power pin 260A and the PCB contact 232 of a second power pin 260B of the first row of pins 236 may connect to lanes of the PCB 300 that provide power. In turn, the first and the second power pins 260A, 260B may each include a plurality of socket contacts 234 to provide electrical connections within the first and/or second sockets 220A, 220 B. Specifically the first power pin 260A and the second power pin 260B may each split or otherwise be connected to other pins such that the first and second power pins 260A, 260B provides power to a plurality of socket contacts 234 that define the first and/or second sockets 220A, 220B. In one embodiment, the first power pin 260A splits into four socket contacts 234 configured per M.2 standard, and traditionally labeled pins twelve, fourteen, sixteen, and eighteen, and the second power pin 260B splits into two socket contacts 234 configured per M.2 standard for pins traditionally labeled two and four. Accordingly, the number of lanes on the PCB 300 that provide power through the connector 200 and to the first and the second SSDs 400A, 400B may be reduced from six lanes to two lanes for the first row of pins 236.

Likewise, in one embodiment, the PCB contact 232 of a third power pin 260C and the PCB contact 232 of a fourth power pin 260D of the second row of pins 238 may connect to lanes of the PCB 300 that provide power. In turn, the third and fourth power pins 260C, 260D may each include a plurality of socket contacts 234 to provide electrical connections within the first and/or second sockets 220A, 220B. Specifically the third power pin 260C and the fourth power pin 260D may each split or otherwise be connected to other pins such that the third and fourth power pins 260C, 260D may include a plurality of socket contacts 234 that define the first and/or second sockets 220A, 220B. In one embodiment, the third power pin 260C splits into four socket contacts 234 configured per M.2 standard, and traditionally labeled pins twelve, fourteen, sixteen, and eighteen, and the second power pin 260D splits into two socket contacts 234 configured per M.2 standard for pins traditionally labeled two and four. Accordingly, the number of lanes on the PCB 300 that provide power through the connector 200 and to the first and the second SSDs 400A, 400B may be reduced from six lanes to two lanes for the second row of pins 238.

In one embodiment, pins in addition to those that are standard in an M.2 connection arrangement may be added to the first row of pins 236 and the second row of pins 238 for connection to the PCB 300. The added pins may be positioned into otherwise unused space of the connector housing 210 so that the connector 200 may include a smaller form factor and take up minimum space on the PCB 300.

In one embodiment, pins may be added to the first row of pins 236 and the second row of pins 238 and routed through mechanical keyed gaps in the connector housing 210. The mechanical keyed gaps in the connector housing 210 are voids in the connector housing 210 where pins are usually not placed. For example, an M.2 connector may be in a “M” key or “B” key configuration, which includes a mechanical key gap after either 5 socket connections or 6 socket connections, respectively, and in one embodiment of the subject matter would position additional pins in those mechanical key gaps. FIG. 4 illustrates a group of pins 270 that may be routed through the mechanical keyed gap usually found in double stack connectors 200, according to one embodiment.

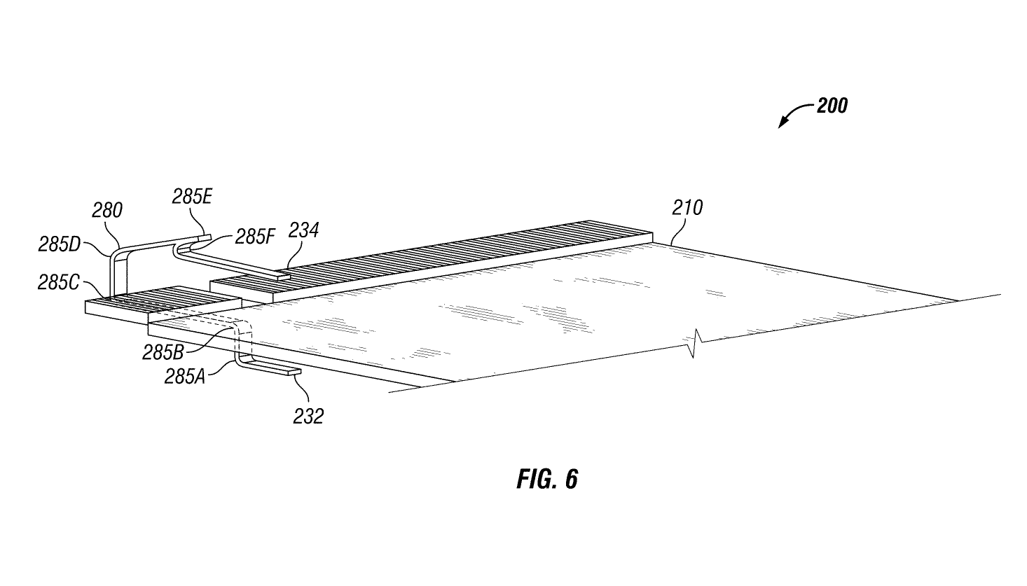

In one embodiment, the double stack connector 200 may include one or more shared pins 280 through the housing 210. Shared pins 280 may be routed through unused space or mechanical keyed gaps in the housing 210. FIG. 6 provides a cutaway drawing of the double stack connector 200 in FIG. 1 showing one example of a shared pin 280 within the connector housing 210. The shared pin 280, which is one of the plurality of pins 230 of a connector 200, may include a PCB contact 232 that extends outward from the bottom portion 218 of the connector 200. The shared pin 280 can include one or more bends 285A-F at any angle along a length of the pin 280, wherein the shared pin 280 may avoid any other pin or component within the housing body 210 of the connector 200. The shared pin 280 may include a socket contact 234 that terminates in one or both of the first and second sockets 220A, 220B. In one embodiment, the purpose of the one or more bends 285A-F is to provide the ability to terminate in both of the first and second sockets 220A, 220B by routing through the unused space or mechanical keyed gaps. In one embodiment, the shared pins 280 may include the shared power pins 260 discussed above. For example, in one embodiment, the shared pin 280, which may be one of the shared power pins 260, may be first routed to one of the socket connections 234 in the first socket 220A, and then bent through the unused space of the housing to also form one of the socket connections 234 in the second socket 220B.

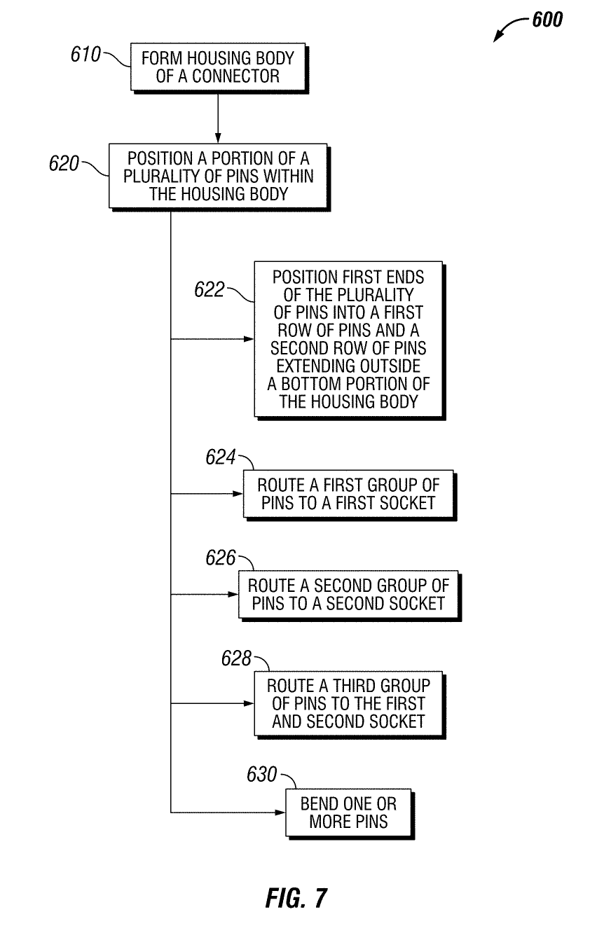

A method 600 of building a double stack connector 200 that electrically connects a first and a second SSD 400A, 400B to a PCB 300, as described above, is further contemplated, and depicted in FIG. 7. In step 610, the method 600 may include forming a housing body 210 of a connector 200 (the connector 200 is shown in FIG. 2). As previously disclosed, the connector 200 may include a first face 212, a back face 214, an upper portion 216, and a bottom portion 218. The housing body 210 may define a first socket 220A and a second socket 220B, wherein the first and second sockets 220A, 220B may extend from the first face 212 of the housing body 210 towards the back face 214 of the housing body 210. The first and second sockets 220A, 220B may be vertically positioned within the housing body, and configured to receive the first and second SSDs 400A, 400B.

In one embodiment, the method 600 of building a connector 200 may include positioning a portion of the plurality of pins 230 within the housing body 210, as shown in step 620 in FIG. 7. The plurality of pins 230 may have PCB contacts 232 and socket contacts 234, and the plurality of pins 230 may comprise a first group of pins 240A and a second group of pins 240B.

In one embodiment, and shown in step 622, the method 600 may include positioning the PCB contacts 232 of the plurality of pins 230 in a first row of pins 236 and a second row of pins 238. In one embodiment the first row of pins 236 and the second row of pins 238 may be physically positioned according to specifications of an M.2 configuration. In another embodiment, the first row of pins 236 or the second row of pins 238 may include pins that are in addition to those that are standard according to the specifications of an M.2 configuration. The PCB contacts of the plurality of pins 230 may extend outside the bottom portion of the housing body 210 to electrically connect the connector 200 to the PCB 300.

In step 624 of the method 600, the first group of pins 240A may be routed to a first socket 220A, and in step 626, the second group of pins 240B may be routed to a second socket 220B. The socket contacts of the first group of pins 240A may electrically connect to the first SSD 400A, and the socket contacts of the second group of pins 240B may electrically connect to the second SSD 400B.

In one embodiment, the plurality of pins 230 may further comprise a third group of pins 240C. In step 628, the third group of pins 240C may be routed to both the first socket 220A and the second socket 220B.

In step 630, one or more of the plurality of pins 230 may be bent in order to connect to the first SSD 400A, and/or the second SSD 400B.

The foregoing description, for purposes of explanation, used specific nomenclature to provide a thorough understanding of the disclosure. However, it will be apparent to one skilled in the art that the systems and methods described herein can be practiced without such. The foregoing descriptions of specific examples are presented for purposes of illustration and description. They are not intended to be exhaustive of or to limit this disclosure to the precise forms described. Obviously, many modifications and variations are possible in view of the above teachings. The examples are shown and described to best explain the principles of this disclosure and practical applications, to thereby permit others skilled in the art to best utilize this disclosure and various examples with various modifications as are suited to the particular use contemplated. It is intended that the scope of this disclosure be defined by the claims and their equivalents below.

1. A connector comprising:
a housing body comprising a front face, a back face, an upper portion, and a bottom portion, the housing body defining a plurality of sockets that extend from the front face of the housing body towards the back face of the housing body, the plurality of sockets vertically stacked within a bottom portion of the housing body and a top portion of the housing body, each of the sockets within the plurality of sockets configured to receive an M.2 module with an M.2 standard specification in a horizontal position; and
a plurality of pins that each comprise:
a printed circuit board (“PCB”) contact that extend out of the bottom portion of the housing body,
at least one socket contact within one of the plurality of sockets, and
a portion between the PCB contact and the at least one socket contact that extends through an interior of the housing body,
wherein the respective PCB contacts of the plurality of pins are arranged in two rows that are configured to connect to a PCB, and
the plurality of pins configured such that receiving the M.2 modules into the plurality of sockets and connecting the PCB contacts of the plurality of pins to the PCB causes all of the M.2 modules to be electrically connected to the PCB such that they are able to operate concurrently.

2. The connector of claim 1, wherein each of the two rows are configured according to an M.2 standard specification.

3. The connector of claim 1, wherein the connector omits one or more M.2 standard signals.

4. The connector of claim 1, wherein the plurality of pins includes additional pins to those in a standard M.2 specification in one or both of the two rows.

5. The connector of claim 1, wherein one or more of the plurality of pins include a shared pin, wherein the shared pin includes a first socket contact in a first socket a second socket contact in a second socket, the first and second sockets included in the plurality of sockets.

6. A connector that electrically connects a first and a second solid state device (SSD) to a printed circuit board (PCB), comprising:
a housing body defining a first socket and a second socket that are configured to receive, in a horizontal position, the first SSD and the second SSD respectively, wherein the first socket is stacked on top of the second socket;
a first row of pins and a second row of pins configured to allow concurrent operation of the first and the second SSDs, each pin comprising a PCB contact extending outward from a bottom portion of the housing body for electrical connection to the PCB and a socket contact for electrical connection to either the first SSD or the second SSD, the first row of pins and the second row of pins each comprising a first group of pins extending through the housing body to the first socket for electrical connection to the first SSD and a second group of pins extend through the housing body to the second socket for electrical connection to the second SSD.

7. The connector of claim 6, wherein the first row of pins and the second row of pins are positioned in an M.2 configuration at the PCB contacts and at the socket contacts.

8. The connector of claim 6, wherein the first row of pins and the second row of pins are positioned in a configuration designated by an M.2 specification at the socket contacts for connection to the first and second SSDs and include additional pins to the configuration designated by the M.2 specification at the PCB contacts for connection to the PCB.

9. The connector of claim 8, wherein the additional pins are positioned in areas designated as mechanical gaps in the housing body in the M.2 specification.

10. The connector of claim 6, wherein one or more pins in the first row of pins and the second row of pins each have one PCB contact and multiple socket contacts.

11. The connector of claim 6, wherein the connector comprises shared power pins.

12. The connector of claim 6, wherein the connector omits the use of one or more standard M.2 signals from the PCB.

13. The connector of claim 6, wherein the connector uses one or more M.2 signals from the PCB for an alternative use than in an M.2 specification.

14. The connector of claim 6, wherein the connector includes one or more shared pins out of the plurality of pins that terminate in both the first socket and the second socket.

15. The connector of claim 14, wherein one or more of the shared pins are bent in at least one place along a length of the pin to position the shared pin within a mechanical gap in the housing body.

16. The connector of claim 6, wherein the connector connects to the PCB via only the first row of pins and the second row of pins.

17. A method of building a connector that electrically connects a first and a second solid state device (“SSD”) to a printed circuit board (“PCB”), the connector allowing the first and the second SSDs to be concurrently operated by the PCB, comprising:
forming a housing body that includes a first face, a back face, an upper portion, and a bottom portion, the housing body further defining a first socket and a second socket, the first and the second sockets extending from the first face of the housing body towards the back face of the housing body and vertically positioned, in relation to the PCB, within the housing body, the first and the second sockets configured to receive the first and the second SSDs in a horizontal position;
positioning a portion of a plurality of pins within the housing body, the plurality of pins having PCB contacts and socket contacts, the plurality of pins further comprising a first group of pins and a second group of pins,
further positioning the PCB contacts of the plurality of pins to extend outside the bottom portion of the housing body to electrically connect to the PCB;
routing the first group of pins through the housing body to the first socket, the socket contacts of the first group of pins for electrical connection to the first SSD; and
routing the second group of pins through the housing body to the second socket, the socket contacts of the second group of pins for electrical connection to the second SSD.

18. The method of claim 17, further comprising positioning the PCB contacts of the plurality of pins into a first row of pins and a second row of pins, to electrically connect to the PCB.

19. The method of claim 18, further comprising adding additional pins to the first row of pins and/or the second row of pins from what is standard in an M.2 specification.

20. The method of claim 18, further comprising bending one or more pins from the first row of pins and/or the second row of pins within the connector housing so that the one or more pins electrically connect to both the first and the second SSDs.
